(19) United States
(12) Patent Application Publication
(10) Pub. No.: US 2016/0051939 A1
(43) Pub. Date: Feb. 25, 2016

(54) NANOCOMPOSITE ULTRA-THIN SEPARATION MEMBRANE AND METHOD FOR MANUFACTURING THE SAME

(71) Applicant: GWANGJU INSTITUTE OF SCIENCE AND TECHNOLOGY, Buk-gu, Gwangju (KR)

(72) Inventors: Heechul CHOI, Gwangju (KR); Moon SON, Gwangju (KR); Lei LIU, Gwangju (KR); Hosik PARK, Gwangju (KR); Hyeon-gyu CHOI, Gwangju (KR)

(73) Assignee: GWANGJU INSTITUTE OF SCIENCE AND TECHNOLOGY, Gwangju (KR)

(21) Appl. No.: 14/760,203

(22) PCT Filed: May 6, 2013
(86) PCT No.: PCT/KR2013/003906

§ 371 Date: Oct. 15, 2015

(30) Foreign Application Priority Data
Dec. 27, 2012 (KR) 10-2012-0154858

(51) Int. Cl. B01D 69/14; B01D 67/00; B01D 69/12; B01D 71/56; B01D 71/68; B01D 71/02

(52) U.S. Cl. CPC B01D 69/148; B01D 71/68; B01D 71/021; B01D 69/122; B01D 71/56; B01D 67/0013; B01D 67/0016; B01D 2325/36; B01D 2323/36

(57) ABSTRACT

The present invention relates to a nanocomposite ultra-thin separation membrane and a method for manufacturing the same, wherein the nanocomposite ultra-thin separation membrane for seawater desalination according to the present invention includes: 1) a polyamide-based polymer active layer; 2) a polyethersulfone support membrane; 3) an external support body; and 4) carbon nanotube, to remarkably improve hydrophilicity of the porous support membrane, thereby having more than doubled water permeability of the entire separation film. In addition, due to a physiochemical reaction of the functionalized carbon nanotube, a support membrane exposed to air for a long period of time is also usable as a lower body of the ultra-thin separation membrane.

### CROSS REFERENCE TO RELATED APPLICATION

This application claims the priority of Korean Patent Application No. 10-2012-0154858, filed on Dec. 27, 2012 in the KIPO (Korean Intellectual Property Office). Further, this application is the National Phase application of International Application No. PCT/KR2013/003906 filed May 6, 2013, which designates the United States and was published in Korean.

### TECHNICAL FIELD

The present invention relates to a nanocomposite ultra-thin separation membrane and a method for manufacturing the same, and more specifically, to a carbon nanotube/polyamide-based polymer nanocomposite ultra-thin separation membrane for seawater desalination capable of having a high hydrophilicity and water permeability as compared to the existing ultra-thin separation membranes, and a method for manufacturing the same.

### BACKGROUND ART

United Nations Development Programme (UNDP) stated that about 12 million people corresponding to 25% of the world's population are suffering from water shortage, and Nature reported that 5.6 billion people corresponding to 80% of the world's population live in areas experiencing a high level of threats to human water security [Human Development Report (2006), Balancing water supply and wildlife (2010)]. As a solution of the water shortage phenomenon, research into reverse osmosis (RO) have been actively conducted, wherein an osmosis membrane to be used needs to be considered as a priority since it is directly related with osmotic pressure functioning as a driving force. Accordingly, a ultra-thin film composite (TFC) for reducing the osmotic pressure has received attention.

Generally, a TFC separation membrane includes an external support body, a support membrane (porous base layer), an active layer (ultra-thin film dense layer) at the same time. Here, a hydraulic reverse osmosis pressure to be required is high as about 40 bars to 60 bars, the kinds and structures of the active layer directly contacting water, and hydrophilicity of the support membrane are main influencing factors on water permeability performance of the TFC separation membrane.

A polyamide (PA)-based polymer is capable of being synthesized into a size of hundreds of nanometers by interfacial polymerization, and accordingly, research and commercialization into the polyamide-based polymer for being applied as an active layer which is a ultra-thin film dense layer have been actively conducted. In the case of the support membrane, polysulfone (PSU) has compression resistance, water permeability, and in particular, high stability against acidic conditions, which has been regarded as a suitable material for synthesis of TFC separation membrane by the subsequent interfacial polymerization. However, due to high polarity and hydrophilicity of polyethersulfone (PES), PES produces a larger amount of finger-like pores than that of PSU to increase water permeability, and has high flexibility of the material itself to significantly increase mechanical strength of the separation membrane as compared to PSU, such that it may be appreciated that PES is more appropriate for water treatment.

Currently, a ultra-thin film separation membrane for reverse osmosis developed by NanoH₂O Inc. is the only commercial separation membrane asserted as a nanocomposite; however, performance and used substances thereof cause controversy [Christopher J. Kurth et al., 2010]. Meanwhile, when a functionalized carbon nanotube composite polyethersulfone (PES) separation membrane is utilized as a composite mixed with an organic membrane, water permeability and membrane fouling resistance are increased as recently reported [Korean Patent Application No. 2010-0064452; Celik, E., Heechul, C., et al., 2011]. Accordingly, research into a carbon nanotube composite single membrane has been conducted, and in the case of the composite membrane, only a method for immersing carbon nanotube into the active layer has been studied [Korean Patent Application Nos. 2010-0138687 and 2010-0140150].

### DISCLOSURE

### Technical Problem

Problems to be solved according to the present invention are as follows.

An aspect of the present invention is to provide a carbon nanotube/polymer nanocomposite ultra-thin separation membrane as a separation membrane material for reverse osmosis, capable of having a low required driving pressure and high water permeability due to a support membrane having high hydrophilicity as compared to the existing polymer ultra-thin separation membranes and being manufactured by a simple method, and a method for manufacturing the same.

### Technical Solution

In accordance with one aspect of the present invention, there is provided a method for manufacturing a nanocomposite ultra-thin separation membrane, wherein the nanocomposite ultra-thin separation membrane includes: 1) a polyamide-based polymer active layer; 2) a polyethersulfone support membrane; 3) an external support body; and 4) carbon nanotube.

In addition, in accordance with another aspect of the present invention,

there is provided a method for manufacturing a nanocomposite ultra-thin separation membrane, including:

a) forming a polyethersulfone support membrane on an external support body,

b) oxidative-modifying a surface of carbon nanotube by using a mixed acidic solution including a nitric acid and a sulfuric acid mixed at a volume ratio of 3:1,

c) mixing the polyethersulfone polymer with an organic solvent, the surface-modified carbon nanotube, and a pore-forming additive, to manufacture a nanocomposite support membrane,

d) casting the nanocomposite support membrane,

e) vaporizing the casted nanocomposite in the air, and immersing the nanocomposite into a coagulation bath for coagulation to induce phase inversion, and

f) interfacial-polymerizing a polyamide active layer on the synthesized support body/support membrane lower structural body.

### Advantageous Effects

The carbon nanotube/polymer nanocomposite ultra-thin separation membrane according to the present invention has a composite structure of 1) an external support body having mechanical strength against reverse osmotic pressure, 2) a support membrane including an oxidative surface-modified carbon nanotube/polyethersulfone polymer, wherein the oxidative surface-modified carbon nanotube is obtained by using a mixed acidic solution including a nitric acid and a sulfuric acid mixed at a volume ratio of 3:1, and 3) an interfacial-polymerized polyamide active layer, to thereby remarkably increase water permeability due to high hydrophilicity as compared to the existing polymer membrane, and to be simply manufactured.

### DESCRIPTION OF DRAWINGS

FIGS. 1a and 1b are transmission electron microscope (TEM) images of a commercial carbon nanotube (CNT) purchased from Hanwha Nanotech.

FIGS. 2a and 2b are transmission electron microscope (TEM) images of a carbon nanotube with an oxidative-modified surface.

FIG. 3 shows analysis of functional groups of the commercial carbon nanotube and the surface-modified carbon nanotube by Fourier transform infrared spectroscopy (FT-IR), Nicolet iS10, USA.

FIGS. 4a and 4b show analysis of a surface and a cross-sectional structure of a support membrane of a carbon nanotube/polyamide nanocomposite ultra-thin separation membrane by scanning electron microscope (SEM), S-4700, USA.

FIGS. 5a and 5b show analysis of surface structures of active layers of the carbon nanotube/polyamide nanocomposite ultra-thin separation membrane and a commercial polyamide ultra-thin membrane composite by scanning electron microscope (SEM), S-4700, USA.

FIG. 6 shows analysis of an entire cross-sectional structure of the carbon nanotube/polyamide nanocomposite ultra-thin separation membrane by scanning electron microscope (SEM), S-4700, USA.

FIG. 7 shows comparison between a polyamide ultra-thin separation membrane and the carbon nanotube nanocomposite ultra-thin separation membrane in view of water permeability (flux).

### BEST MODE

Hereinafter, various aspects and embodiments of the present invention will be described in detail.

According to an aspect of the present invention, there is provided a nanocomposite ultra-thin separation membrane including (a) a support body layer; (b) a support membrane layer formed on the support body; and (c) an active layer formed on the support membrane, wherein a functionalized carbon-nanotube is included only in the support membrane layer among the support body layer, the support membrane layer, and the active layer.

Unlike (i) a case in which the functionalized carbon nanotube is included only in the active layer among the three layers, or (ii) a case in which the functionalized carbon nanotube is included both in the support membrane layer and the active layer, it is confirmed that when the functionalized carbon-nanotube is included only in the support membrane layer according to the present invention, hydrophilicity, water permeability, and membrane fouling resistance are highly maintained, and when the nanocomposite ultra-thin separation membrane is applied to a reverse osmotic membrane, a low driving pressure is required.

According to an exemplary embodiment of the present invention, the support body is selected from polyethylene terephthalate (PET), polypropylene (PP), cellulose acetate (CA), a blend of two or more thereof, and a copolymer of two or more thereof; the support membrane is a polyethersulfone (PES)-based polymer; the active layer is a polyamide (PAm)-based polymer; and the carbon nanotube is a mufti-walled carbon nanotube.

According to another aspect of the present invention, there is provided a method for manufacturing a nanocomposite ultra-thin separation membrane, the method including: (A) obtaining a dispersion for forming a support membrane, the dispersion including a support membrane polymer, a functionalized carbon nanotube, a pore-forming additive, and a dispersion medium; (B) using the dispersion for forming a support membrane to form a support membrane layer on a support body by a phase-inversion method; and (C) forming an active layer on the support membrane layer by interfacial polymerization.

According to an embodiment of the present invention, step (B) above includes: (B1) casting the dispersion for forming the supporting membrane on the support body; (B2) vaporizing at least one portion of the dispersion medium in the casted dispersion for forming the supporting membrane; and (B3) contacting the layer obtained by (B1) and (B2) above with a non-solvent of the support membrane polymer to aggregate the support membrane polymer.

According to another exemplary embodiment of the present invention, step (C) above includes: (C1) applying a diamine-based first monomer on the support membrane; and (C2) contacting a carbonyl group-containing second monomer on the diamine-based first monomer layer to perform a reaction.

According to another exemplary embodiment of the present invention, before step (B) above is performed, (B0) applying the dispersion medium on the support body and removing an excess solution is further performed.

By further performing the step as described above, it is confirmed that adhesion between interfaces may be improved, and a thickness of a membrane to be formed may be remarkably decreased.

According to still another exemplary embodiment of the present invention, after step (C2) above is performed, step (C) above further includes: (C3) annealing the active layer obtained by the interfacial polymerization; and (C4) air-cleaning the annealed active layer by using inert gas.

By further performing the steps as described above, it is confirmed that the active layer has more compact density, water permeability is high maintained, and adsorption of impurities is rather significantly deteriorated.

According to still another exemplary embodiment of the present invention, the support body is selected from polyethylene terephthalate (PET), polypropylene (PP), cellulose acetate (CA), a blend of two or more thereof, and a copolymer of two or more thereof; the support membrane is a polyethersulfone (PES)-based polymer; the pore-forming additive is polyvinyl pyrrolidone (PVP); the dispersion medium is selected from N-methyl-2-pyrrolidone (NMP), dimethylformamide (DMF), and dimethylacetamide (DMAc); the non-solvent is deionized water; the active layer is a polyamide (PAm)-based polymer; the diamine-based first monomer is m-phenylenediamine (MPD); the carbonyl group-containing second monomer is trimesoyl chloride (TMC); and the carbon nanotube is a multi-walled carbon nanotube.

According to still another exemplary embodiment of the present invention, step (B0) above is performed by applying the dispersion medium and positioning a sheet-type adsorbent on the support body for 5 seconds to 1 minutes; step (B2) above is performed for 10 to 30 minutes; and step (C3) above is performed by leaving the active layer at 50-70° C. for 30 seconds to 10 minutes.

In particular, when the time required for step (B2) above is out of the above-described range, the pore structure has a finger-like shape, and when it is applied to reverse osmosis, a pre-compression process is separately required. Meanwhile, when the time required for step (B2) above has the above-described range, the pore structure is converted from the finger-like shaped structure into a sponge structure, and when it is applied to reverse osmosis, the pre-compression process is not separately required.

According to still another exemplary embodiment of the present invention, the carbon nanotube is functionalized by (A1) removing impurities with an acid solution, followed by (A2) dry neutralization and an atomic layer deposition method.

In particular, it is confirmed that when functionalization of the carbon nanotube is performed by an atomic layer deposition method, water permeability is remarkably increased while maintaining membrane fouling resistance almost as it is.

According to still another exemplary embodiment of the present invention, the carbon nanotube in the dispersion for forming the supporting membrane has an amount of 0.05-2 wt %.

Hereinafter, various other exemplary embodiments of the present invention will be described in detail.

The carbon nanotube may have a diameter of several to several tens of nms, a length of several tens to several hundreds of μms, and a large structural anisotropy, and may have various structures such as a single-walled structure, a mufti-walled structure, and a bundle (rope) structure. Preferably, the carbon nanotube may have a multi-walled structure. The carbon nanotube is classified into zigzag, armchair, and chiral types according to rolled angles, which is related with electrochemical properties such as metallicity and semiconductor property, and therefore, the carbon nanotube is not limited to one type.

The above-described carbon nanotube may be manufactured by arc discharge, laser ablation, chemical vapor deposition, thermal chemical vapor deposition, pyrolysis of hydrocarbon, high pressure carbon monoxide process (HiPCO), and the like. Preferably, the carbon nanotube may be synthesized by thermal chemical vapor deposition; however, the present invention is not limited thereto.

The carbon nanotube is functionalized by using a nitric acid (HNO₃) and a sulfuric acid (H₂SO₄). The mufti-walled carbon nanotube is subjected to reverse circulation at 100° C. using a mixed acidic solution including a nitric acid and a sulfuric acid mixed at a volume ratio of 3:1 so as to remove impurities, and washed with distilled water so as to have an acidity (pH) of 6 to 7. The acid solution having the same ratio as used above is added to the resultant solution, followed by ultrasonic vibration at 70° C., to attach functionalized groups on the surface of the carbon nanotube.

The polyethersulfone (PES) polymer support membrane may include at least one polymer having aryl group monomers and sulfuric acid group monomers such as polysulfone (PSU) and polyethersulfone, and preferably, may include polyethersulfone. However, the present invention is not limited thereto.

The organic solvent for dissolving the polymer for the support membrane may include at least one of N-methyl-2-pyrrolidone (NMP), dimethylformamide (DMF), dimethylacetamide (DMAc), and the like, and preferably, may include N-methyl-2-pyrrolidone (NMP). However, the present invention is not limited thereto.

The polyvinylpyrrolidone added to the polymer for the support membrane is a pore-forming agent, and has a molar mass of 10,000 or 40,000 or 360,000, in particular, preferably, has a molar mass of 10,000. However, the present invention is not limited thereto.

In the manufacturing the support membrane of the present invention, the carbon nanotube may be dispersed by ultrasonication after mixing the polymer solvent.

The polyethersulfone and the polyvinyl pyrrolidone preferably have a weight ratio of 15-25 wt %, and a weight ratio of 0.1 wt %, based on total solution. However, the present invention is not limited thereto. In addition, the carbon nanotube preferably has a weight ratio of 0.05 to 2 wt %, more preferably, 0.5 to 2 wt %, based on the total solution. However, the present invention is not limited thereto.

In addition, the support membrane of the method for manufacturing a nanocomposite ultra-thin separation membrane according to the present invention is manufactured by including a step of casting the nanocomposite polymer for a support membrane on the external support body by using an organic solvent as an adhesive and a step of vaporizing the casted nanocomposite in the air, and immersing the nanocomposite into a coagulation bath for coagulation to induce phase inversion. A solution of the coagulation bath is preferably deionized water; however, the present invention is not limited thereto.

In the method for manufacturing a nanocomposite ultra-thin separation membrane according to the present invention, the above-described casting may be performed by methods known in the art, and may be performed by using a casting knife; however, the present invention is not limited thereto.

The vaporizing of the nanocomposite polymer solution is preferably performed within the range of 30 seconds to 1 minute; however, the present invention is not limited thereto.

Time required for coagulation in the coagulation bath is preferably within 30 minutes to 1 hour; however, the present invention is not limited thereto.

In order to form the active layer, interfacial-polymerization of m-phenylenediamine (MPD) and trimesoyl chloride (TMC) is preferably performed; however, the present invention is not limited thereto.

To form the active layer, it is preferable to contact an upper part of the support membrane with m-phenylenediamine having an amount of 2 wt % based on the organic solvent, for 10 minutes; however, the present invention is not limited to the above-described wt % and time. The used solvent is preferably deionized water; however, the solvent is not limited thereto, but may be any inorganic solvent.

From the above-described separation membrane, an excess solvent may be removed by using methods in the art, and may be removed by using a rubber roller; however, the present invention is not limited thereto. Then, it is preferable to react the resultant solution with trimesoyl chloride (TMC) having an amount of 0.1 wt % for 30 seconds; however, the present invention is not limited to the above-described wt % and time.

Right after performing the interfacial-polymerization, it is preferable to heat the active layer at 60° C. for 1 minute to further densify the dense layer of the polymer; however, the present invention is not limited thereto.

It is preferable to remove impurities on surfaces of the synthesized nanocomposite ultra-thin separation membrane by using an inert gas and store the nanocomposite ultra-thin separation membrane in deionized water; however, the present invention is not limited thereto.

The carbon nanotube/polymer nanocomposite ultra-thin separation membrane manufactured according to the present invention is capable of having a low required driving pressure and high water permeability due to the support membrane having a high hydrophilicity as compared to the existing polymer ultra-thin separation membranes, and is capable of being manufactured by a simple method.

Hereinafter, the present invention will be described in detail through the following Examples; however, it is not construed as limiting the scope or the spirit of the present invention. In addition, as long as a person skilled in the art practices the present invention based on the disclosed description of the present invention including the following Examples, it is obvious that the present invention may be easily practiced by a person skilled in the art even though experimental results are not specifically provided.

### EXAMPLE

### Manufacture Example 1

### Manufacture of Surface-Modified CNT

Multi-walled carbon nanotube (multi-walled CNT) having a diameter of 10-15 nm and an apparent density of about 0.05 g/cm³ which was manufactured by a thermal chemical vapor deposition method, was purchased from Hanwha Nanotech. The carbon nanotube purchased for oxidative surface-modification was subjected to acid treatment to introduce a hydrophilic functional group, thereby increasing hydrophilicity of a material itself. 150 mg of the carbon nanotube was maintained at 100° C. in a mixed acidic solution including a nitric acid (70%) and a sulfuric acid (98%) mixed at a volume ratio of 3:1, followed by reverse stirring for 3 hours, to remove impurities. After stirring, the carbon nanotube was washed with deionized water until reaching pH 7, and dried at room temperature for 12 hours. The dried carbon nanotube was added to the same mixed acidic solution as described above, followed by ultrasonication at 70° C. for 9 hours, to attach hydrophilic functional groups, and washed with deionized water until reaching pH 7, and dried in a vacuum oven overnight.

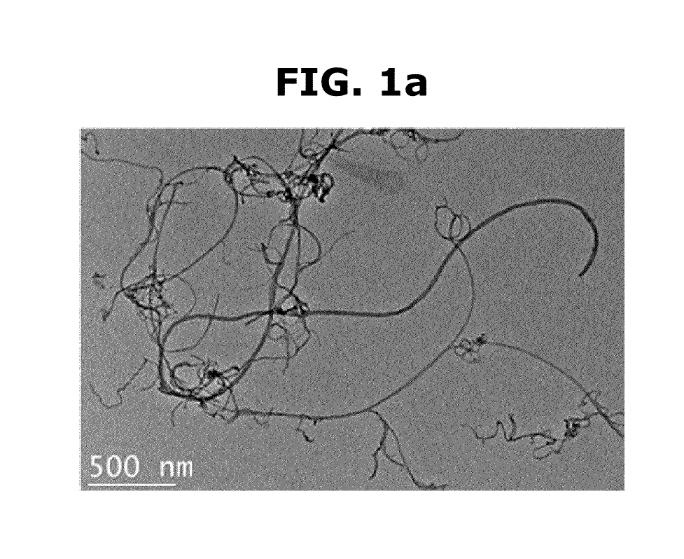

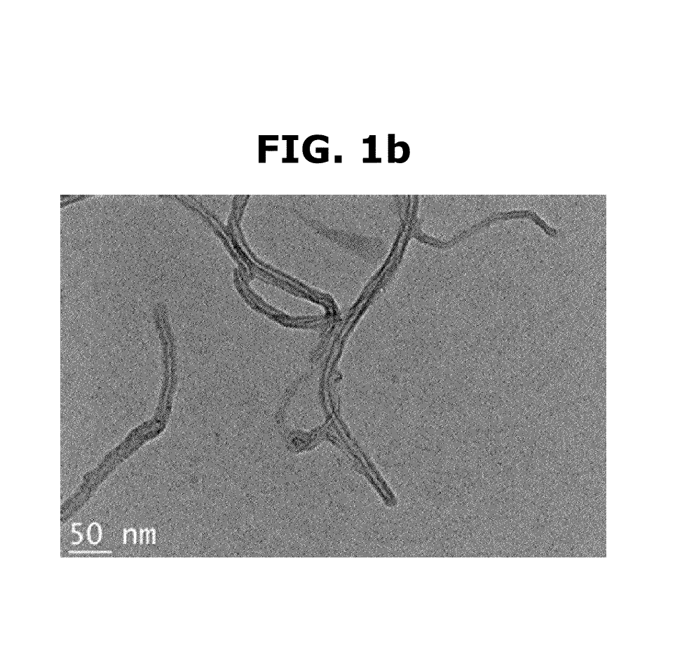

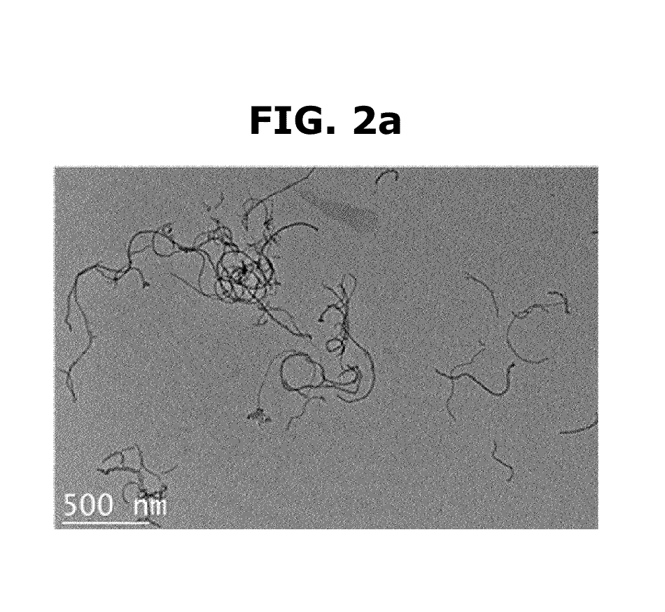

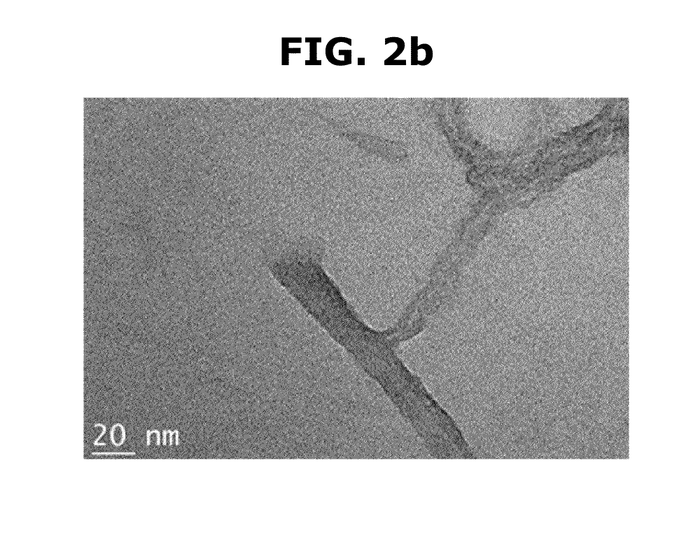

The commercial carbon nanotube (CNT) manufactured by a thermal chemical vapor deposition method and the oxidative surface-modified carbon nanotube of Manufacture Example 1 were analyzed by transmission electron microscope (TEM), JEOL-2100, Japan and the results thereof were shown in FIGS. 1a and 1b and 2a and 2b, respectively. The commercial carbon nanotube which was not surface-modified had a length of 1 μm or more, and ends thereof mostly had a closed structure. Meanwhile, the surface-modified carbon nanotube had a shortened length of about 500 nm, and ends thereof had an open structure.

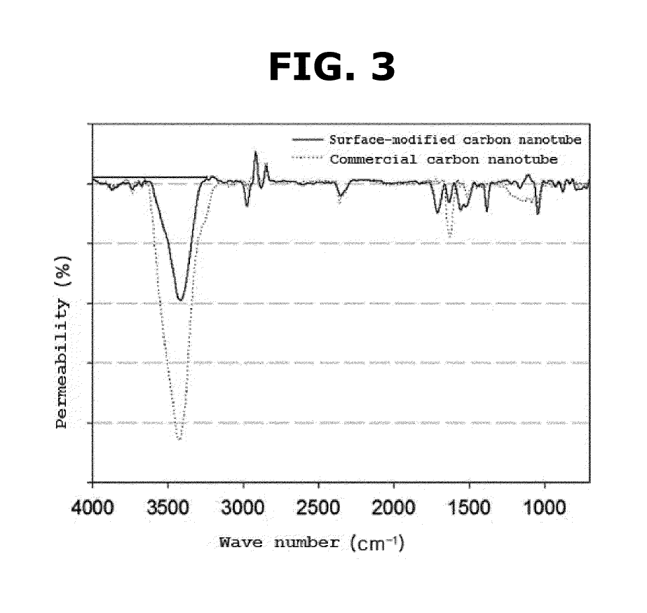

Functional groups of the surface-modified carbon nanotube of Manufacture Example 1 were analyzed by Fourier transform infrared spectroscopy (FT-IR), Nicolet iS10, USA, and the results thereof were shown in FIG. 3. The surface-modified carbon nanotube had three peak of ˜3,440 cm⁻¹, ˜1,630 cm⁻¹, and ˜1,380 cm⁻¹ corresponding to a hydroxyl group (—OH), a carbonyl group (>C═O), carboxyl group (—COON) and a phenol group (O—H). In the case of the carbonyl group (>C═O), a vibration peak due to chemical bond was shown around 1,630 cm⁻¹.

### Example 1

### Manufacture of Carbon Nanotube/Polyamide Nanocomposite Ultra-Thin Separation Membrane

The carbon nanotube/polyamide nanocomposite ultra-thin separation membrane was manufactured by synthesizing the support membrane by a phase-inversion method and synthesizing the active layer by interfacial polymerization. Hereinafter, the practiced synthesis method is described.

In order to dissolve the polyethersulfone polymer, the surface-modified carbon nanotube of Manufacture Example 1 as an additive, polyvinyl pyrrolidone having a molar mass of 10,000 as a pore-forming additive, and N-methyl-2-pyrrolidone (NMP) as a solvent were added to complete a solution for a support membrane. The added carbon nanotube had an amount of 2 wt %, and was uniformly dispersed in the polymer solvent by ultrasonication at 40° C. for 3 hours. A small amount of N-methyl-2-pyrrolidone (NMP) was applied onto a commercialized polyethylene terephthalate external support body, and an excess solution was removed. The above-described solution for the support membrane was applied to have a thickness of 200-300 μm to perform a casting process. The casted solution was exposed to the air for 30 seconds, and put into deionized water functioning as a coagulation liquid, to induce phase-inversion for 30 minutes, thereby completing the support membrane.

In order to form the active layer on the synthesized support membrane, m-phenylenediamine (MPD) having an amount of 2 wt % based on the total solvent was dissolved in deionized water to be in contact with an upper part of the support membrane for 10 minutes, and then an excess solvent was removed by a rubber roller. Then, 0.1 wt % of trimesoyl chloride was dissolved in n-hexane to perform interfacial-polymerization of the corresponding membrane for 30 seconds. Right after performing the interfacial-polymerization, the synthesized active layer was heated at 60° C. for 1 minute to further densify the dense layer of the polymer, impurities on surfaces thereof were removed by using an inert gas, and the resultant product was stored in deionized water.

### Comparative Example 1

### Manufacture of Polyamide Ultra-Thin Separation Membrane

A polyamide ultra-thin separation membrane was manufactured by synthesizing a support membrane by a phase-inversion method and synthesizing an active layer by interfacial polymerization. The practiced synthesis method was the same as Example 1 above, but carbon nanotube was not added in this synthesis method. The detailed description thereof is described below.

In order to dissolve the polyethersulfone polymer, N-methyl-2-pyrrolidone (NMP) as a solvent and polyvinyl pyrrolidone having a molar mass of 10,000 as a pore-forming additive were added to complete a solution for a support membrane. The polymer solvent was uniformly dispersed by ultrasonication at 40° C. for 3 hours. A small amount of N-methyl-2-pyrrolidone (NMP) was applied onto a commercialized polyethylene terephthalate external support body, and an excess solution was removed. The above-described solution for the support membrane was applied to have a thickness of 200-300 μm to perform a casting process. The casted solution was exposed to the air for 30 seconds, and put into a deionized water functioning as a coagulation liquid, to induce phase-inversion for 30 minutes, thereby completing the support membrane.

In order to form the active layer on the synthesized support membrane, m-phenylenediamine (MPD) having an amount of 2 wt % based on the total solvent was dissolved in deionized water to be in contact with an upper part of the support membrane for 10 minutes, and then an excess solvent was removed by a rubber roller. Then, 0.1 wt % of trimesoyl chloride was dissolved in n-hexane to perform interfacial-polymerization of the corresponding membrane for 30 seconds. Right after performing the interfacial-polymerization, the synthesized active layer was heated at 60° C. for 1 minute to further densify the dense layer of the polymer, impurities on surfaces thereof were removed by using an inert gas, and the resultant product was stored in deionized water.

The surface-modified carbon nanotube synthesized by Example 1 above was analyzed by transmission electron microscope (TEM), JEM-2100, Jeol, Japan, and the results thereof were shown in FIG. 2. After the surface-modification, the carbon nanotube having a length of 1 μm or more was shortened to about 500 nm, and ends thereof were open.

Surface functional groups of a synthesized polyamide ultra-thin composite membrane and the carbon nanotube/polyamide nanocomposite ultra-thin separation membrane were analyzed by Fourier transform infrared spectroscopy (FT-IR), Nicolet iS10, USA, and the results thereof were shown in FIG. 3. Both of two separation membranes had a peak of −3,440 cm⁻¹ corresponding to a hydroxyl group (—OH); however, peaks of −1,715 cm⁻¹, −1,640 cm⁻¹, −1,400 cm⁻¹, and −1,370 cm⁻¹ corresponding to ketone (C═O), carbonyl group (>C═O), carboxylate (—COO—), and carboxyl group (—COON) were remarkably shown in the carbon nanotube/polymer nanocomposite ultra-thin separation membrane.

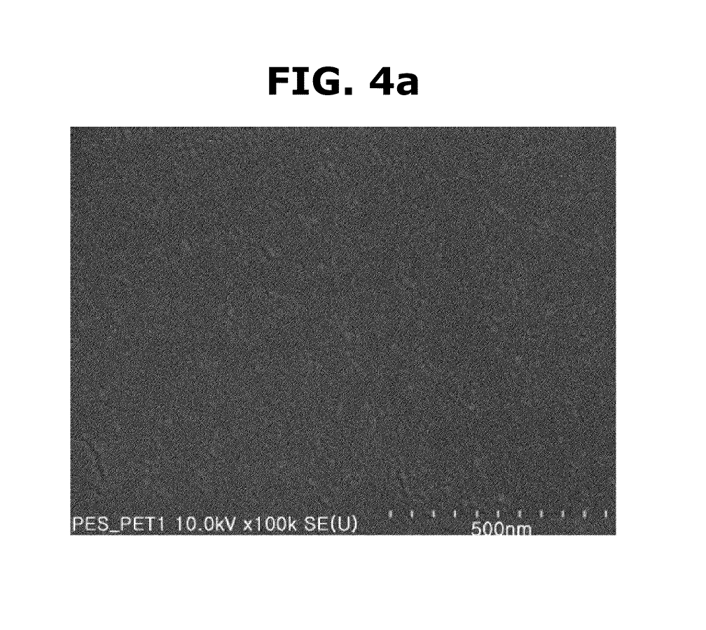

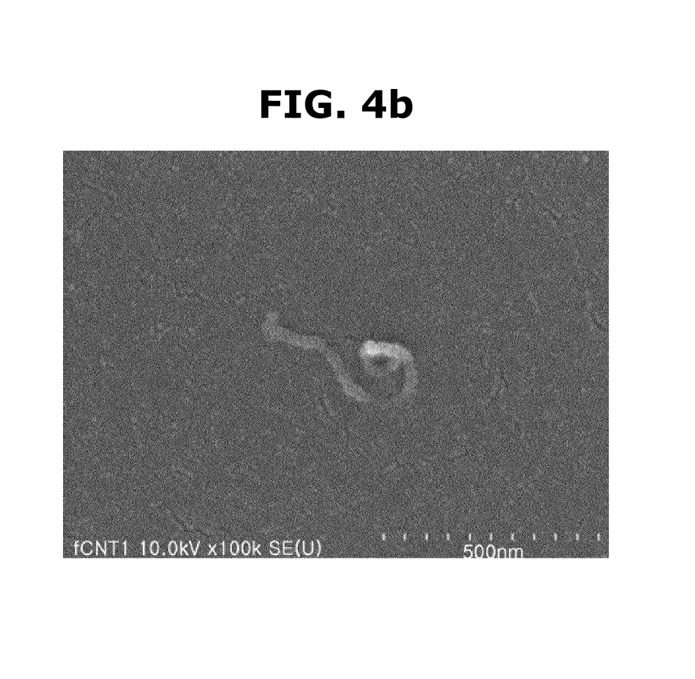

A surface and a cross-sectional structure of the support membrane of the carbon nanotube/polyamide nanocomposite ultra-thin separation membrane were analyzed by scanning electron microscope (SEM), S-4700, USA, and the results thereof were shown in FIGS. 4a and 4b, respectively. It was shown that the functionalized carbon nanotube with the shortened length was uniformly dispersed on the surface and the cross section of the support membrane. In addition, it could be appreciated through the cross section that the lower layer had macropores, and the upper layer had a compact asymmetric structure and finger-like shaped pores.

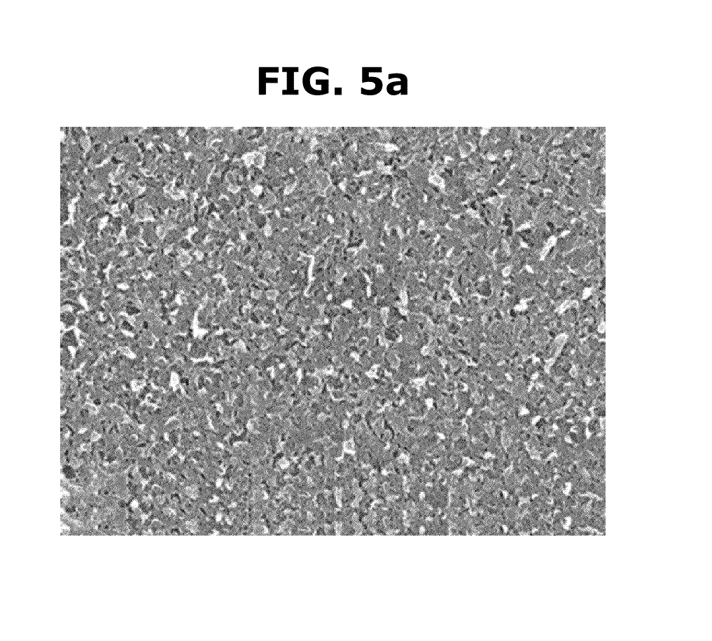

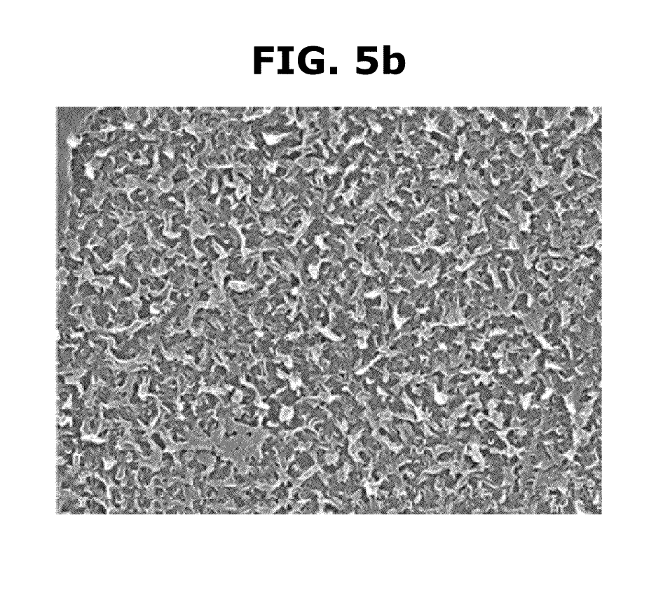

Surface structures of the active layers of the carbon nanotube/polyamide nanocomposite ultra-thin separation membrane and the commercial polyamide ultra-thin composite membrane were analyzed by scanning electron microscope (SEM), S-4700, USA, and the results thereof were shown in FIGS. 5a and 5b, respectively. It was shown that both of the active layers in the separation membranes had a dense polyamide tissue due to the interfacial-polymerization, and had cross-linked forms each of which is significantly different from the polyethersulfone support membrane, and surface pores were not observed.

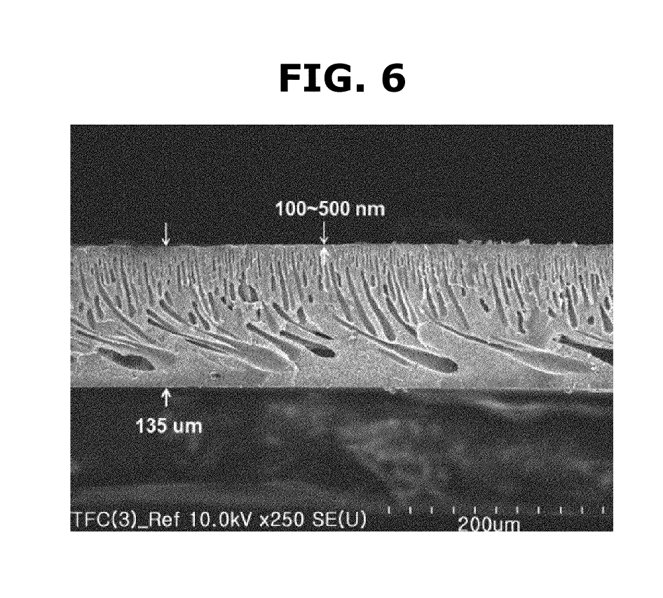

An entire cross-sectional structure of the carbon nanotube/polyamide nanocomposite ultra-thin separation membrane was shown in FIG. 6. The ultra-thin separation membrane had a thickness of about 135 μm except for a thickness of the external support body.

Surface hydrophilicities of a polyethersulfone ultrafiltration membrane reported in the art, the support membrane of Example 1, and a 2 wt % of CNT composite polyether sulfone ultrafiltration membrane (Celik, E., Heechul, C., et al., 2011) were measured by a device for measuring water contact angle (contact angle goniometer, Model 100, USA), and the results thereof were shown in Table 1 below.

TABLE 1

| Separation membrane | Water Contact Angle (°) |
|---|---|
| Polyethersulfone | 72 |
| Example 1 | 59 |
| Celik and Choi | 60 |

It could be appreciated from the results of Table 1 above that the surface-modified carbon nanotube remarkably increased hydrophilicity of the separation membrane.

Surface hydrophilicities of Example 1, Comparative Example 1, and the commercial ultra-thin separation membrane were measured by a device for measuring water contact angle (contact angle goniometer, Model 100, USA), and the results thereof were shown in Table 2 below.

TABLE 2

| Separation Membrane | Water Contact Angle (°) |
|---|---|
| Example 1 | 68 |
| Comparative Example 1 | 70 |
| Commercial | 70 |

It was confirmed from the results of Table 2 above that even though the carbon nanotube was mixed in the support membrane, the active layer had a unique contact angle of polyamide.

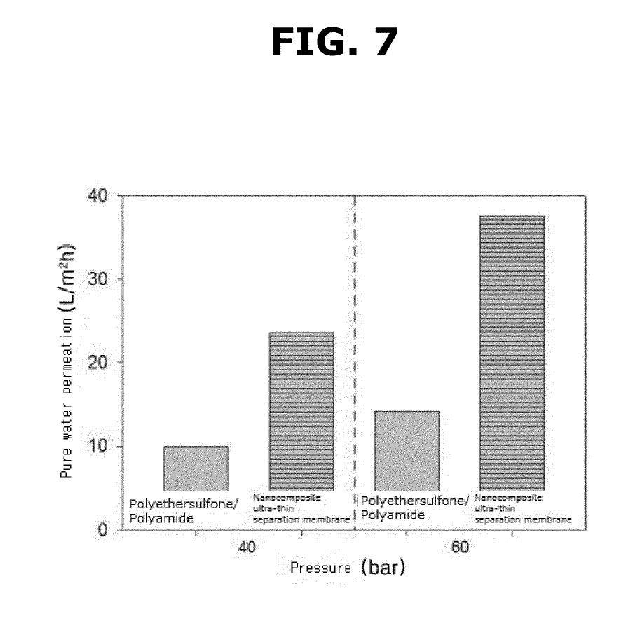

Water permeabilities of Example 1 and Comparative Example 1 were measured by a laboratory-scale reverse osmotic process, and the results thereof were shown in FIG. 7 and Table 3. The operation conditions thereof were as follows: NaCl 2000 ppm of blackish water at a pressure of 40 and 60 bar, a temperature of 20±1° C., a circulation flow rate of 600 cm³/min, and an effective area of 30 cm².

TABLE 3

| Separation | | Water Permeability |
|---|---|---|
| Membrane | Pressure (bar) | (L/m²h) |
| Example 1 | 40 | 23.60 |
| Comparative | 40 | 9.92 |
| Example 1 | | |
| Example 1 | 60 | 37.60 |
| Comparative | 60 | 14.18 |
| Example 1 | | |

It could be appreciated from the results of Table 3 above that the carbon nanotube/polyamide nanocomposite ultra-thin separation membrane of Example 1 had more than doubled water permeability as compared to Comparative Example 1, which is considered because the surface-modified carbon nanotube increased hydrophilicity of the support membrane having the thickest part in the ultra-thin separation membrane to significantly reduce a required driving pressure which is essential for water permeation.

### INDUSTRIAL APPLICABILITY

The carbon nanotube/polymer nanocomposite ultra-thin separation membrane according to the present invention has a composite structure of 1) an external support body having mechanical strength against reverse osmotic pressure, 2) a support membrane including an oxidative surface-modified carbon nanotube/polyethersulfone polymer, wherein the oxidative surface-modified carbon nanotube is obtained by using a mixed acidic solution including a nitric acid and a sulfuric acid mixed at a volume ratio of 3:1, and 3) an interfacial-polymerized polyamide active layer, to thereby remarkably increase water permeability due to high hydrophilicity as compared to the existing polymer membrane, and to be simply manufactured.

1. A nanocomposite ultra-thin separation membrane comprising:
(a) a support body layer;
(b) a support membrane layer formed on the support body; and
(c) an active layer formed on the support membrane,
wherein a functionalized carbon-nanotube is included only in the support membrane layer among the support body layer, the support membrane layer, and the active layer.

2. The nanocomposite ultra-thin separation membrane of claim 1, wherein the support body is selected from polyethylene terephthalate (PET), polypropylene (PP), cellulose acetate (CA), a blend of two or more thereof, and a copolymer of two or more thereof;
the support membrane is a polyethersulfone (PES)-based polymer;
the active layer is a polyamide (PAm)-based polymer; and
the carbon nanotube is a multi-walled carbon nanotube.

3. A method for manufacturing a nanocomposite ultra-thin separation membrane, the method comprising:
(A) obtaining a dispersion for forming a support membrane, the dispersion including a support membrane polymer, a functionalized carbon nanotube, a pore-forming additive, and a dispersion medium;
(B) using the dispersion for forming a support membrane to form a support membrane layer on a support body by a phase-inversion method; and
(C) forming an active layer on the support membrane layer by interfacial polymerization.

4. The method of claim 3, wherein step (B) includes:
(B1) casting the dispersion for forming the supporting membrane on the support body;
(B2) vaporizing at least one portion of the dispersion medium in the casted dispersion for forming the supporting membrane; and
(B3) contacting the layer obtained by (B1) and (B2) above with a non-solvent of the support membrane polymer to aggregate the support membrane polymer.

5. The method of claim 3, wherein step (C) includes:
(C1) applying a diamine-based first monomer on the support membrane; and
(C2) contacting a carbonyl group-containing second monomer on the diamine-based first monomer layer to perform a reaction.

6. The method of claim 4, wherein before step (B) is performed, (B0) applying the dispersion medium on the support body and removing an excess solution is further performed.

7. The method of claim 6, wherein after step (C2) is performed, step (C) further includes:
(C3) annealing the active layer obtained by the interfacial polymerization; and
(C4) air-cleaning the annealed active layer by using inert gas.

8. The method of claim 7, wherein the support body is selected from polyethylene terephthalate (PET), polypropylene (PP), cellulose acetate (CA), a blend of two or more thereof, and a copolymer of two or more thereof;
the support membrane is a polyethersulfone (PES)-based polymer;
the pore-forming additive is polyvinyl pyrrolidone (PVP);
the dispersion medium is selected from N-methyl-2-pyrrolidone (NMP), dimethylformamide (DMF), and dimethylacetamide (DMAc);
the non-solvent is deionized water;
the active layer is a polyamide (PAm)-based polymer;
the diamine-based first monomer is m-phenylenediamine (MPD);
the carbonyl group-containing second monomer is trimesoyl chloride (TMC); and
the carbon nanotube is a multi-walled carbon nanotube.

9. The method of claim 8, wherein step (B0) is performed by applying the dispersion medium and positioning a sheet-type adsorbent on the support body for 5 seconds to 1 minutes;
step (B2) is performed for 10 to 30 minutes; and
step (C3) is performed by leaving the active layer at 50-70° C. for 30 seconds to 10 minutes.

10. The method of claim 9, wherein the carbon nanotube is functionalized by (A1) removing impurities with an acid solution, followed by (A2) dry neutralization and an atomic layer deposition method.

11. The method of claim 10, wherein the carbon nanotube in the dispersion for forming the supporting membrane has an amount of 0.05-2 wt %.
